(19) United States
(12) Patent Application Publication
(10) Pub. No.: US 2007/0220762 A1
(43) Pub. Date: Sep. 27, 2007

(54) Optical marking device

(75) Inventors: Stefan Clauss, Stuttgart (DE); Gunter Flinspach, Leonberg (DE)

Correspondence Address: Striker Striker & Stenby, 103 East Neck Road, Huntington, NY, 11743, US

(73) Assignee: ROBERT BOSCH GMBH, STUTTGART (DE)

(21) Appl. No.: 10/590,257

(22) PCT Filed: Jul. 6, 2005
(86) PCT No.: PCT/EP05/53220

§ 371 Date: Aug. 22, 2006

(30) Foreign Application Priority Data
Aug. 17, 2004 (DE) 10 2004 039 746.5

(51) Int. Cl. G01C 15/02

(52) U.S. Cl. 33/281

(57) ABSTRACT

The invention relates to an optical marking device having at least one light source (20, 22, 24; 32, 34, 36), and having means for generating a first optical projection line (26) on a reference face (10), as well as means for generating a second optical projection line (30) on the same reference face (10), and the second optical projection line (30) forms an angle of 90° with the first projection line (26).

According to the invention, it is proposed that means (20, 22, 24; 32, 34, 36) are present which generate a third projection line (28), and the third projection line assumes an angle of 45° to the first optical projection line (26) and an angle of 45° to the second optical projection line (30). The invention also relates to a tool device having an optical marking device of this kind.

The invention relates to an optical marking device having means for generating a first and a second optical signal on a reference face, as generically defined by the preamble to claim 1.

### PRIOR ART

In order to perform the most various levelling, aligning and marking tasks in the do-it-yourself field and in interior construction, for some time laser products have been used that depending on their use generate laser markings in order to pick up existing references from floors, ceilings or walls. Among them, a distinction is made between so-called rotation lasers, in which a laser signal is fanned out in a plane to be established by rotation of the light source or by rotation of a beam-deflecting component and a reference face is thus defined. On the other hand, so-called linear lasers are known, which by projecting the laser signal onto a reference face make it possible to make a predetermined direction visible so that it can thus be adhered to. So-called laser spirit levels are also known, for example, whose housings can be levelled in a desired plane and which emit one or more laser beams for marking purposes.

From German Utility Model DE 29716316 U1, for instance, a device for levelling and/or for making markings on walls is known, which has a housing with at least one suspension device and with an opening for a laser beam. In the housing, a laser beam generator is suspended, swinging freely, from a pendulum shaft.

From European Patent Disclosure EP0785412A2, a laser levelling device is known, with an elongated housing and bubble levels. A laser module with laser beam optics is integrated with the housing and generates a laser beam. A sighting device with a crosshair and notch is mounted movably on the housing. Thanks to the embodiment of the notch as a vertical gap, the projection point of the laser beam can be detected and calibrated precisely to a point even at great distances or great ambient brightness.

From German Patent Disclosure DE 19929436 A1, a beam splitter for splitting a focused beam into split beams is known that has a number of reflective faces which are located in the beam path of a collimated primary beam of light generated by a light source. The reflective faces are each inclined by 45° to the propagation direction of the primary beam and split the arriving primary beam into split beams extending at right angles to one another, creating a virtual Cartesian coordinate system.

### ADVANTAGES OF THE INVENTION

The optical marking device of the invention has means for generating a first and a second optical projection line, and the second optical projection line forms an angle of 90° with the first projection line. Advantageously, there are means in the optical marking device of the invention that make it possible to generate a third projection line, which forms an angle of 45° with both the first optical projection line and the second optical projection line.

With the known devices for generating an optical marking, it is not possible to represent a line at an angle of 45° from two lines that are oriented at right angles to one another. A user must therefore ascertain such a line himself inconveniently, for instance by calculating applicable angle functions and calibrating the device accordingly. The advantage of the invention that even a so-called 45° line can be represented directly with the device of the invention and thus can be drawn by a user without major effort, for instance on a reference face.

Advantageous embodiments and refinements of the device of the invention as defined by claim 1 are obtained with the characteristics recited in the dependent claims.

Advantageously, the first, second and third projection lines are located in the same plane. In this way, it is possible to generate a 450 orientation on a reference face. The projection lines that are at an angle of 900 to one another can be used as reference lines for contact with one or more walls, for instance.

The third projection line is advantageously also embodied as an optical projection line. This makes it possible for instance to generate the three optical projection lines by means of only a single light source, especially a single laser signal. This has the advantage in particular that the calibration of the light source, such as a laser diode, is greatly simplified. In this advantageous embodiment of the device of the invention, the three optical projection lines are generated by means of an optical element from the signal of the single light source. This kind of optical element can for instance have a holographic diffraction grating or some other diffractive or refractive structure.

In an alternative embodiment, the three optical projection lines are generated by at least one light source, and in particular at least one laser. In particular, it is possible to use one laser for each projection line. Such a laser can generate the desired projection line by means of a simple optical element, such as a cylinder lens. In this embodiment, the three projection lines are calibrated to one another upon assembly of the device or assembly of a tool device that includes the device. Such a construction has the advantage that the optical element for generating lines is relatively economical, although then three laser diodes are required for generating the three projection lines.

Advantageously, with the optical marking device of the invention, a tool device can be implemented which advantageously makes it possible to locate objects along a 45° projection line to a reference line, for instance. In this way, without major effort, floor tiles can for instance be laid diagonally in a room, or else from a diagonal line, the tiles can be laid parallel to a wall in a corresponding way.

In an advantageous embodiment of the tool device of the invention, the device for generating the optical marking is suspended in the manner of a pendulum laser in a housing of the tool device. With such a construction, the tool device is self-levelling in the horizontal plane because of the pendulum technique employed.

In alternative embodiments, it is possible for the device of the invention to be fixedly built into a housing of the tool device, with the device aligned with the edges of the tool device. It can also be provided that the device of the invention be located calibratably in a corresponding tool device, for instance being supported on a trivet.

A tool device of the invention advantageously has a user control concept that makes it possible to switch the emission of the optical projection line outward out of the housing of the tool device individually. In the user control concept of the tool device of the invention, it is thus conceivable either for all the projection lines to be switched on and off at once, or for each individual projection line to have its own switch element. Advantageously, a user control concept for the tool device of the invention is possible in which, with one switch, it is possible to switch back and forth among the individual optical projection lines.

The optical marking device of the invention and the tool device provided with the device of the invention make it advantageously possible to generate and represent even a line at a 45° angle to another projection line without major effort, so that drawing a 45° to a baseline is made easily possible.

Further advantages of the device of the invention will become apparent from the ensuing description of an exemplary embodiment.

### DRAWING

In the drawing, exemplary embodiments for tool devices of the invention are shown with the optical marking device of the invention, which is to be described in further detail in the ensuing description. The drawing figures, their description, and the claims include numerous characteristics in combination. We can simply consider these characteristics individually as well and put them together to make further useful combinations that are thus also to be considered as being disclosed in the specification.

Shown are:

FIG. 1, a schematic illustration of a first instance of use of an exemplary embodiment of a tool device of the invention;

FIG. 2, a second exemplary embodiment for a tool device of the invention, in a schematic illustration of a second instance of use.

### DESCRIPTION OF THE EXEMPLARY EMBODIMENT

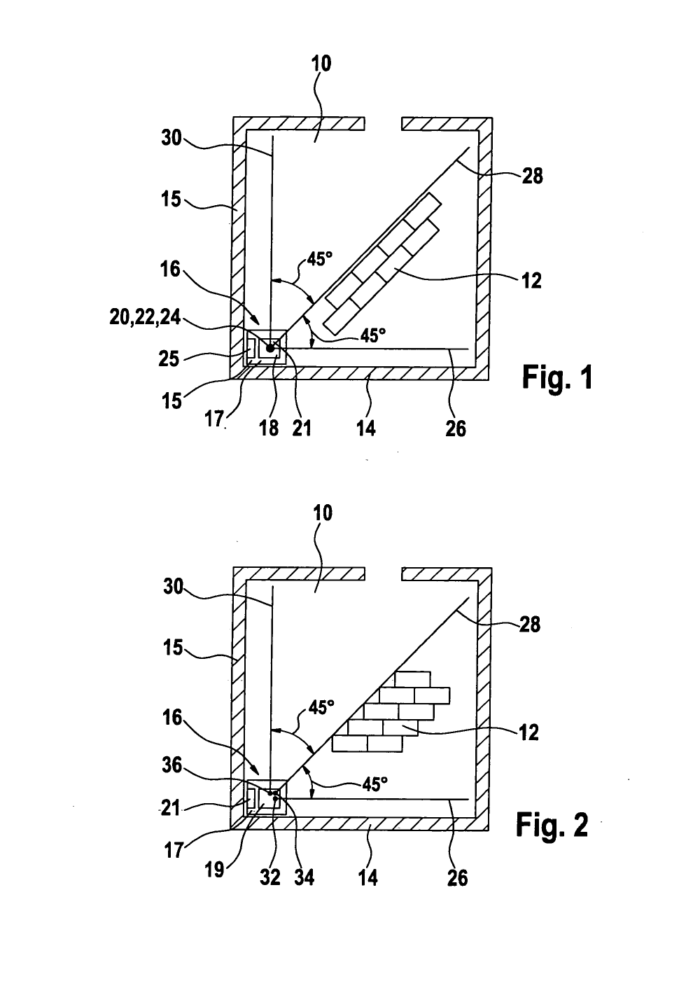

FIG. 1 shows a typical situation for using an optical marking device of the invention and a tool device of the invention with such an optical marking device. Tiles 12, for instance, are intended to be laid on the floor 10 of a room at an angle of 45° to a wall 14.

The tool device 16 of the invention has a housing 17 with an optical marking device 18 with a light source 20 in the form of a laser 22, in particular a laser diode 24. Via a holographic diffraction grating 21, the beam of the light source 20 is split into three partial beams. In alternative embodiments of the device of the invention, however, three separate light sources and in particular three laser diodes may be present, which each generate one partial beam.

Via a suitable optical element, such as a cylinder lens, each partial beam is flared out in the plane perpendicular to the floor 10, so that a laser beam intersects the plane of the floor 10, which serves as a reference plane in the exemplary embodiment of FIG. 1, and thus generates a respective projection line 26, 28, 30 on the surface of the floor 10. In the exemplary embodiment of FIG. 1, the three projection lines thus all have a common origin or starting point.

Besides the use of a cylinder lens for generating the fanned-out partial beams or for generating the optical projection lines 26, 28, 30 on a reference face 10, it is equally possible for other optical components to be used, such as suitably embodied diffraction structures. In particular, it is advantageous to use a single optical diffraction element 21, in order on the one hand to achieve the splitting into three partial beams 26, 28, 30 and on the other to widen each partial beam in a plane that extends perpendicular to the plane 10 defined by the partial beams. Such an element 21 could also be embodied as a diffraction grating, especially a holographic diffraction grating. In that case, the optical projection lines would be represented by individual discrete points on the reference face 10. Another possibility is a refractive element which generates the three partial beams.

In use, the tool device 16 of the invention is oriented in a room in such a way that two projection beams 26, 30 of the optical marking device 18 extend as parallel as possible to two walls 14 and 15, respectively, of the room. For this purpose, a calibration device 25 can be provided, which makes it possible to calibrate the orientation of the optical marking device 18 inside the tool device 16 so that the parallelism, for instance of the projections 26 and 30, with the corresponding wall 14 and 15, respectively, exists. In the exemplary embodiment of FIG. 1, the optical marking device 18 is built in fixedly, along with the laser unit, in the tool device 16 of the invention and is calibrated with the edges of that device.

It can also be provided that the optical marking device 18 be designed such that it is located calibratably and in particular rotatably inside the housing 17 of the tool device 16. Advantageously, the tool device 16 of the invention has an axis of rotation for the optical marking device 18 that extends perpendicular to the plane 10 defined by the three partial beams 26, 28, 30.

In alternative embodiments of the tool device 16 of the invention, the optical marking device 18 can additionally be integrated with and suspended in the housing 17 of the tool device 16 in the manner of a pendulum laser. In this way, it is possible for one of the partial beams 26 or 30 to be oriented automatically horizontally by gravity, so that such a device automatically makes a projection line possible at 45° to this horizontal.

In particular, the projection line 28 forms a 450 angle with both the projection line 26 and the projection line 30. With the aid of the orientations thus marked on the floor, the tiles 12 can for instance be placed on the floor 10—along the projection lines 28—so that these tiles likewise form an angle of 45° to the direction of the projection lines 26 and thus to the direction of the wall 14.

By way of suitable openings in the housing 17 of the tool device 16, which can be individually switched or in other words opened or closed, the partial beams 26, 28, 30 can also switched individually, so that the emission from one, two, or all three of the partial beams 26, 28, 30 exits from the housing 17 of the tool device 16.

FIG. 2 shows an alternative exemplary embodiment for a tool device of the invention in a further field of use.

In the exemplary embodiment of FIG. 2, the optical marking device 19 has three individual light sources 32, 34, 36, in the form of three laser diodes, which each emit a beam of light 26, 28, 30 in the portion of the electromagnetic spectrum that is visible to the human eye. The light sources are located such that the three beams appear to come from a common origin, so that the associated axes would intersect one another at a common point. Downstream of the laser diodes, optical elements, such as cylinder lenses, cause each beam of light to be fanned out in a plane. The light sources 32, 34 and 36 are calibrated to one another such that the beams of light that they emit define one common plane 10, which in the exemplary embodiment of FIG. 2 is parallel to the plane of the drawing. Perpendicular to this plane 10, the individual beams 26, 28, 20 are split, creating one section or projection line each of the respective laser beam 26, 28, 30 with the reference planes 10, which is usable as a marking.

Besides the use of cylinder lenses to generate the fanned-out partial beams or for generating the optical projection lines on the reference face, still other optical components, such as suitably embodied diffraction structures, can equally well be used. Such elements could also be embodied as holographic diffraction gratings. In that case, the optical projection lines would be represented on the reference face by individual discrete points.

The three light sources 32, 34 and 36 in the exemplary embodiment of FIG. 2 are advantageously individually switchable. Each of the partial beams 26, 28, 30 in the tool device 16 of the invention or on an external user control unit for the tool device 16 can for instance have its own switch element, or in an alternative embodiment, as shown in FIG. 2, a single switch 21 may be provided, which makes it possible to switch back and forth among the individual partial beams or to switch one or more partial beams on or off.

The tool device 18 of the invention shown in FIG. 1 also advantageously has switch elements which make it possible for one, two, or even all three partial beams to emerge from the device. To that end, suitably closable openings will be provided for instance in the housing 17 of the tool device 18 or on the optical marking device itself, which are activatable by suitable switch elements. Alternatively, including in the embodiment of FIG. 1, switching back and forth between the individual partial beams can be done with a single switch element, corresponding to the switch element 21 of FIG. 2, by opening or closing the appropriate openings in the tool device.

In the user control concept of the tool device 18 or 19 of the invention, it is even conceivable for all the partial beams 26, 28, 30 to be emitted at once from the tool device 18 or 19, or for each partial beam to have its own switch which activates the applicable emission of that partial beam out of the tool device.

In the exemplary embodiment of FIG. 2, the device of the invention makes it possible for the tiles 12 to be laid for instance from a diagonal 38 in the room, this diagonal 38 being marked by the projection line 28, which extends at an angle of 45° to both the projection line 28 and the projection line 30. To that end, all that has to be done is to orient one projection line 26 or 30 parallel to a wall 14 or 15, respectively, using the appropriate calibration means.

In the embodiment of FIG. 2 as well, the optical marking device 19 can for instance be embodied as a pendulum laser that has the light sources 32, 34 and 36. Alternatively, the marking device 19 can be located fixedly in the housing of the tool device, if either the tool device 19 can be calibrated to an external reference plane, or if the optical marking device can be calibrated inside the housing 17 of the tool device 19.

The optical marking device of the invention and the tool device of the invention with such an optical marking device is not limited to the exemplary embodiments shown in the drawings. The third projection line can for instance be in the form of a straightedge or a cord that can be pulled out of the device or out of the housing at an angle of 45° to an optical projection line 26 and 28. It is furthermore possible to design the means that generate the third projection line in such a way that pivoting of the third projection line is possible. In such an embodiment, the third projection line can assume an arbitrary angle of between 0 and 90° to the first and to the second projection lines.

The calibration means of the device of the invention are not limited to the means explicitly mentioned in the exemplary embodiments. The device of the invention may for instance, besides the pendulum laser function, also have bubble levels and/or mechanical calibration means which make it possible to secure the unit, for instance even perpendicular to a wall, and calibrate it.

An electronic information sensor system can also be present in or on the tool device that advantageously makes automatic calibration of the tool device possible, for instance via a suitable actuator system.

In particular, the device of the invention and the tool device of the invention are not limited to being used in laying tiles. On the contrary, the tiles here are only one simple example of the field in which an optical marking device, which according to the invention has means which generate a third projection line which generate an angle of 45° to both a first optical projection line and a second optical projection line, can be used.

1. An optical marking device having at least one light source (20, 22, 24; 32, 34, 36), and having means for generating a first optical projection line (26) on a reference face (10), as well as means for generating a second optical projection line (30) on the same reference face (10), and the second optical projection line (30) forms an angle of 90° with the first projection line (26), characterized in that means (20, 22, 24; 32, 34, 36) are present which generate a third projection line (28), and the third projection line assumes an angle of 45° to the first optical projection line (26) and an angle of 45° to the second optical projection line (30).

2. The device as defined by claim 1, characterized in that the first, second, and third projection lines (26, 28, 30) define a plane (10).

3. The device as defined by claim 1, characterized in that the third projection line (28) is an optical projection line.

4. The device as defined by claim 2, characterized in that at least one projection line (26, 28, 30) is fanned out perpendicular to the reference plane.

5. The device as defined by claim 3, characterized in that the three optical projection lines (26, 28, 30) are generated by at least one light source (20, 22, 24; 32, 34, 36), and in particular by at least one linear laser (22).

6. The device as defined by claim 3, characterized in that the three optical projection lines (26, 28, 30) are generatable by means of a single light source (20, 22, 24), and in particular by means of a single laser signal (22).

7. The device as defined by claim 6, characterized in that the optical projection lines (26, 28, 30) are generatable by means of at least one optical element from the single light source (20, 22, 24).

8. A tool device (16) having a device as defined by claim 1.

9. The tool device as defined by claim 8, characterized in that the device is suspended in the manner of a pendulum laser in a housing (17) of the tool device (16).

10. The tool device as defined by claim 8, characterized in that the device is calibratable relative to the housing (17) of the tool device (16).

11. The tool device as defined by claim 9, characterized in that the emission from the optical projection lines (26, 28, 30) is switchable out of the housing (15) of the tool device (16), and in particular is individually switchable.
